(19) United States
(12) Patent Application Publication
(10) Pub. No.: US 2018/0070773 A1
(43) Pub. Date: Mar. 15, 2018

(54) Food Freshness Device

(71) Applicant: Colony Foods, Inc., Lawrence, MA (US)

(72) Inventor: Edward Charles Noe', Newburyport, MA (US)

(21) Appl. No.: 15/691,353

(22) Filed: Aug. 30, 2017

Related U.S. Application Data
(60) Provisional application No. 62/381,057, filed on Aug. 30, 2016.

(51) Int. Cl. A47J 43/00

(52) U.S. Cl. CPC A47J 43/00

(57) ABSTRACT

A food freshness device for preserving the freshness of prepared food is disclosed. The food freshness device includes a base having a support surface and a plurality of drainage cells bounded by sidewalls, and legs extending a distance from select sidewalls to form flow channels. Flow channels are designed to prevent pooling under the food item within the drainage cells, thereby reducing pooling of the liquid and likelihood of reabsorption into the food item. The disclosure is designed to be supported by a substrate, such as a pizza box or plastic container.

### CROSS-REFERENCE TO RELATED APPLICATIONS

This application claims the benefit of priority to U.S. Provisional Patent Application No. 62/381,057, filed Aug. 30, 2016 and entitled “Food Freshness Device.”

### TECHNICAL FIELD

This disclosure generally relates to a device for keeping prepared foods fresh, more specifically, to a device that supports prepared foods in order to prevent liquids, created by grease and steam, from reabsorbing into the prepared food.

### BACKGROUND

It is known in the art that prepared foods, such as pizzas, calzones, nachos, baked goods, french fries, and the like, do not maintain their texture when put in a container for consumption at home. This is a particular issue with warm, greasy foods because the grease and steam that release from the food are trapped in the container. Once trapped, they pool in the container where they often reabsorb into the food. The same issue occurs with baked goods because they are hot when removed from the oven, and often remain warm until after the item has been sold to a customer. Thus, steam can also cause baked goods to become soggy on the shelf of a bakery when warm baked goods are placed on a display case, shelf, or rack before they are allowed to cool completely. The trapped steam can create liquid water that reabsorbs moisture resulting in sogginess and loss of freshness.

Almost half of all money spent by Americans on food is spent on take-out and delivery food from restaurants. Maintaining the freshness of food is a growing problem because most restaurants now offer delivery, take-out and/or curbside pick-up options in order to remain competitive. A food remains fresh when it retains a consistency, texture, and/or taste, similar to the consistency, texture and/or taste of a food item at the time it is made, thereby providing a home dining experience that is similar to consumption of the food item at the site of preparation. While no food item that is delivered or taken home is going to be the same as when served hot at a restaurant, preventing liquids, created by grease and steam, from reabsorbing into the prepared food helps maintain the prepared food's freshness.

Many foods do not maintain their freshness during the time it takes for a consumer to transport the food home, or for the delivery service to arrive at the customer's home. No customer wants to receive soggy pizza, mushy nachos, or waterlogged baked goods. If a customer has a bad experience with these items, they likely will not purchase them again. Even worse for the restaurant, the customer may go to another restaurant for the items in hope of finding a superior product that maintains its freshness. In this case, the restaurant may lose the customer entirely.

Various attempts have been made to maintain the freshness of foods, particularly pizza and the like, for consumption at home. One type of device elevates the food item off of the bottom of the container by use of a grid. While somewhat helpful, this device allows liquid to pool under the food instead of being drawn away from the bottom of the food item. For example, U.S. Pat. No. D 463,745, discloses a food support for use in a food delivery box that includes a number of cavities. The food item is placed on top of the cavities to elevate the food. In use, the cavities fill with grease or liquid from steam. Once the cavity is full, the liquid is trapped, and may then be re-absorbed into the food item. Because the liquid is trapped, and can be reabsorbed into the food item, these devices are not optimal in allowing foods to maintain their freshness. Likewise, other prior art devices, such as grease sheets, absorb grease from the bottom of prepared food, yet result in the same problem. When the sheet is full of grease, the food item sits in the grease allowing grease to reabsorb into the food.

In addition to the foregoing, certain items, such a pizza with multiple toppings, a calzone, or chicken wings, for example, are heavy and put more weight on the prior designs than other, lighter items, such as french fries. When heavy foods are added, the prior art designs that elevate the food can fail under the weight, and no longer effectively elevate the food item from the bottom of the container. Thus, the food item may sink further into the liquid that has pooled at the bottom of the container, again causing reabsorption of liquid and loss of freshness.

Further, consumers increasingly desire environmentally friendly products. Prior art designs are primarily made of plastic that is not compostable or biodegradable. Over 30% of solid waste in landfills is attributed to food packaging. The prior art devices for preservation of food freshness contribute to this problem, and are therefore less desirable to some consumers.

As will be appreciated, the prior art designs, while somewhat effective, allow for reabsorption of liquids such as grease and steam into the food item, which results in food with compromised freshness that is not as appealing to the consumer.

### SUMMARY

The food freshness device of the present disclosure more effectively retains freshness of prepared foods by providing a device where liquid and steam are dispersed from the bottom of the prepared food item through channels, thus helping to maintain the food's original, intended texture and increased freshness over that of the prior art. The food freshness device includes a base for supporting the food item that has an open cell construction for receiving liquid such as grease or steam, and also includes legs to elevate the prepared food item a distance from a substrate, for example a take-out box, to create flow channels for the liquid. The legs extending below the base to form channels that direct the flow of liquid under the base, thereby aiding in the prevention of pooling and re-absorption of liquids into the food item.

In an exemplary embodiment, the base includes a support surface constructed and arranged to support the food item disposed in a first plane that is substantially parallel to the substrate. Extending from the support surface are a plurality of sidewalls having a depth or length, the sidewalls extending to a second plane, which is substantially parallel to the first plane, the sidewalls defining openings within the base creating drainage cells. The sidewalls are configured and arranged to create any number of drainage cells that are sized to allow liquid and steam to flow and disperse away from the bottom of the drainage cell, and into the flow channels. The depth or length of the sidewalls defines the depth or length of the drainage cells. A select number of sidewalls include legs extending beyond the second plane, the legs contacting the substrate to elevate the base and forming the channels. The legs have a sufficient length, as measured from the bottom of the sidewalls whose length terminates in the second plane, and are spaced from the substrate in order to elevate the food item from the substrate and to create flow channels. The flow channels allow for the drainage of liquid and the dispersion of steam away from the food items. The flow channels aid in preventing pooling of liquid and steam, thus permitting the prepared foods to retain much of their freshness by preventing and minimizing the reabsorption of liquid into the food.

In one embodiment, the legs are all substantially the same length so that the food item is elevated from the substrate evenly, to allow for even drainage onto the substrate. In another embodiment, the legs are different lengths such that the food item is elevated further from the substrate in the one area, and rests more closely to the substrate in another area. In this arrangement the first and second plane are substantially parallel to each other, but may not be entirely parallel to the substrate. This arrangement allows for liquid to flow away from one area of the food item, such as the center, to another area, such as the outer edges. The legs can also be arranged in different lengths in order to create desired drainage patterns away from a food item. For instance, the legs could have a longer length on the front and a shorter length on the back so that liquid could flow to the back of a display case.

In one embodiment, the drainage cells are aligned in a grid pattern of horizontal rows and vertical columns. The drainage cells can be any of a variety of shapes, for example, squares, rectangles, diamonds, hexagons or other shapes, as would be known by those of skill in the art. In another embodiment, the drainage cells are offset, with the rows and columns of drainage cells being staggered creating an offset grid, as may be desired.

In yet another embodiment, the base can be inverted such that in use the legs contact the food item, and the surface along the first plane contacts the substrate. In this embodiment, as the liquid fills a cell, it flows over the sidewalls and into the flow channels. The support surface in this embodiment supports the base on the substrate, instead of the food item on the base.

By adding the freshness device to food containers or displays, restaurants and bakeries can provide a better quality product to customers by retaining more of the original texture, consistency and taste of the food item for longer periods of time.

### BRIEF DESCRIPTION OF THE DRAWINGS

Various aspects of exemplary embodiments are discussed below with reference to the accompanying figures, which are not necessarily drawn to scale, emphasis instead being placed upon illustrating the principles disclosed herein. The figures are included to provide an illustration and a further understanding of the various aspects and embodiments, and are incorporated in and constitute a part of this specification, but are not intended as a definition of the limits of any particular embodiment. The figures, together with the remainder of the specification, serve only to explain principles and operations of the described and claimed aspects and embodiments, but are not to be construed as limiting embodiments. In the figures, each identical or similar component that is illustrated in various figures is represented by a like numeral. For purposes of clarity, not every component may be labeled in every figure. In the figures:

FIG. 1 is a perspective view of the food freshness device according to a first embodiment of the present disclosure;

FIG. 2 is a top plan view of the food freshness device of FIG. 1;

FIG. 3 is cross sectional view taken along lines 3-3 of FIG. 2;

FIG. 4 is an enlarged view of FIG. 3;

FIG. 5 is a side view of the food freshness device of FIG. 1;

FIG. 6 is a side view of the food freshness of FIG. 1 on a substrate and supporting a food item;

FIG. 7 is a perspective view of the food freshness device according to a second embodiment of the present disclosure;

FIG. 8 is a top plan view of the food freshness device of FIG. 7;

FIG. 9 is a cross sectional view taken along lines 8-8 of FIG. 8;

FIG. 10 is an enlarged view of FIG. 9;

FIG. 11 is a side view of a third embodiment, showing legs of different lengths; and

FIG. 12 is a side view of the food freshness device of FIG. 1 inverted on a substrate and supporting a food item.

### DETAILED DESCRIPTION OF THE ILLUSTRATIVE EMBODIMENTS

The examples of the device discussed herein are not limited in application to the details of construction and the arrangement of components set forth in the following description or illustrated in the accompanying drawings. It will be understood to one of skill in the art that the device is capable of implementation in other embodiments and of being practiced or carried out in various ways. Examples of specific embodiments are provided herein for illustrative purposes only and are not intended to be limiting. Also, the phraseology and terminology used herein is for the purpose of description and should not be regarded as limiting. Any references to examples, embodiments, components, elements or acts of the device herein referred to in the singular may also embrace embodiments including a plurality, and any references in plural to any embodiment, component, element or act herein may also embrace embodiments including only a singularity (or unitary structure). References in the singular or plural form are not intended to limit the presently disclosed device, its components, acts, or elements. The use herein of “including,” “comprising,” “having,” “containing,” “involving,” and variations thereof is meant to encompass the items listed thereafter and equivalents thereof as well as additional items. References to “or” may be construed as inclusive so that any terms described using “or” may indicate any of a single, more than one, and all of the described terms. As used herein, the term “freshness” refers to a food item retaining a consistency, texture, and/or taste, similar to the consistency, texture and/or taste of a food item at the time it is made, by limiting the amount of liquid that is reabsorbed into the prepared food once placed in a container or display.

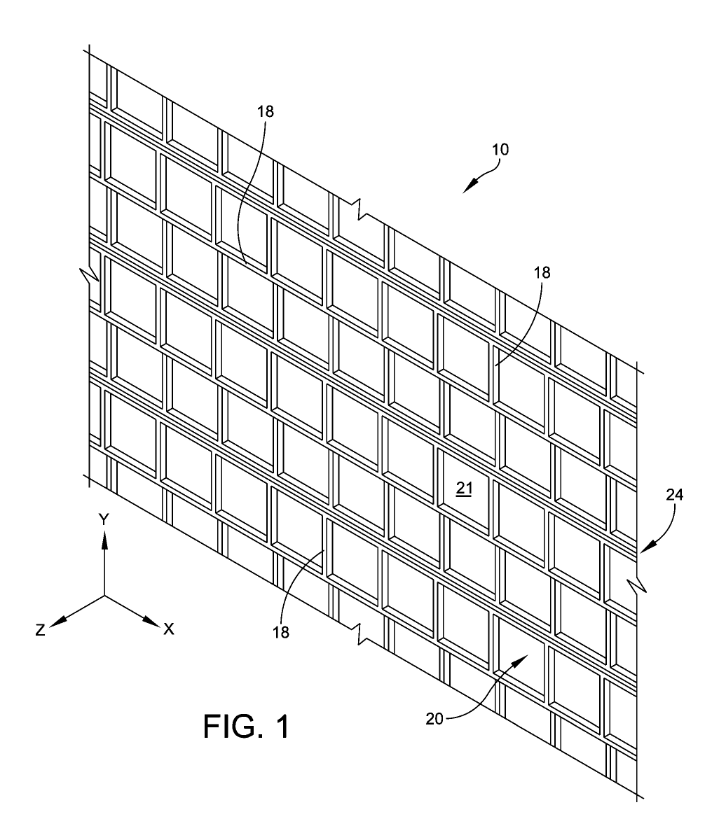

Referring initially to FIGS. 1-6, a first exemplary embodiment of a food freshness device 10 is illustrated. Food freshness device 10 includes a base 24 having a support surface 28 and a plurality of drainage cells 20 bounded by sidewalls 18, and legs 26 extending from select sidewalls 18 to form flow channels 22. Flow channels 22 are designed to reduce pooling under the food item 29 by directing liquid flow away from the food item 29, thereby reducing the likelihood of reabsorption of liquid into the food item 29.

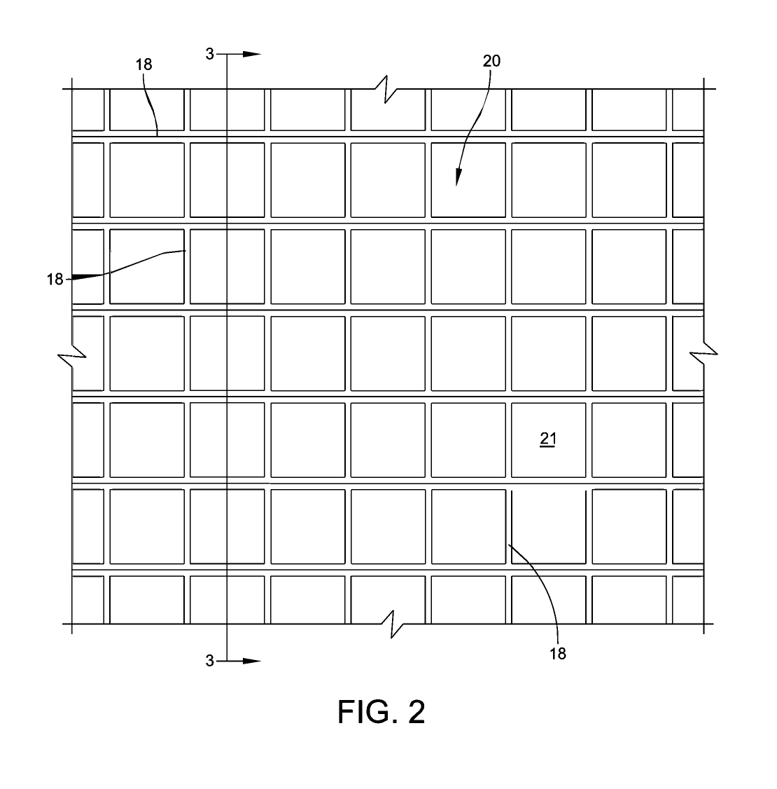

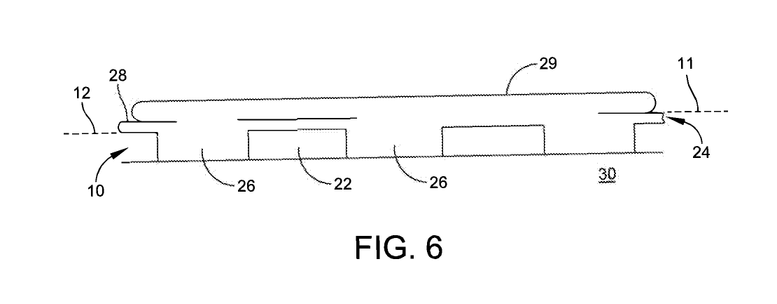

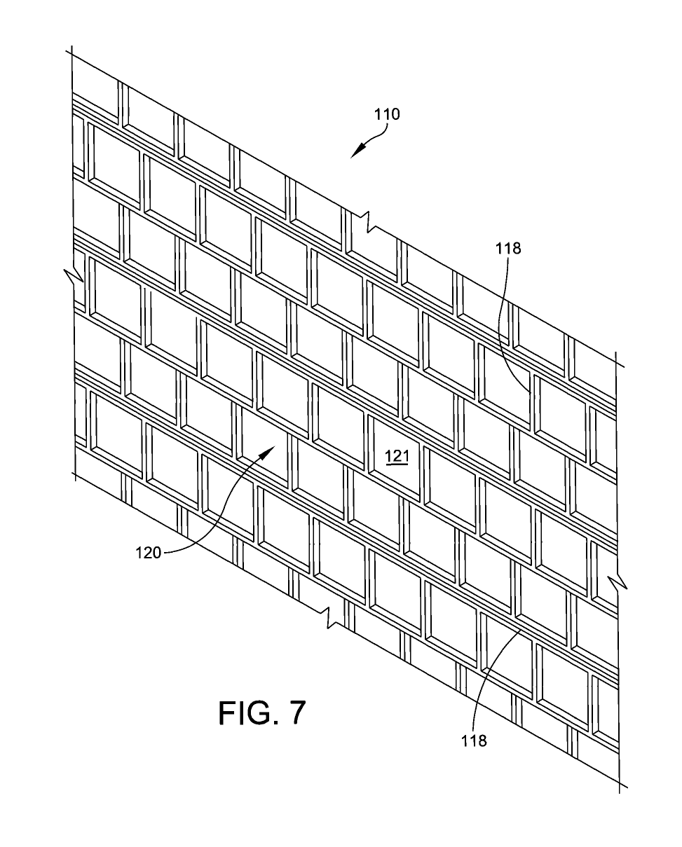

Referring now to FIGS. 5 and 6, the base 24 includes a support surface 28 disposed in a first plane 11, and a second plane 12 substantially parallel to the first plane 11. The support surface 28 is constructed and arranged to support the food item 29 thereon, and may be substantially flat in order to support the food item 29 without displacing toppings, for example sauces or other items. Extending between the support surface 28 and second plane 12 are sidewalls 18 (FIG. 2). The sidewalls 18 are constructed and arranged to form drainage cells 20. As best shown in FIGS. 1 and 2, the sidewalls 18 are arranged such that they circumscribe and define openings 21 of drainage cells 20 within base 24. The depth of the drainage cells 20 is defined by the length of the sidewall 18. The drainage cells 20 are arranged in an open construction that join together to form an array of drainage cells 20, such that a grid, mesh, lattice, or grate design is formed. The drainage cells 20 may be aligned in horizontal rows and vertical columns as shown in FIGS. 1 and 2, or may be offset as described in greater detail below. While the present embodiment shows drainage cells 20 as square shaped, it is understood by one of skill in the art that the drainage cells 20 can have any desired shape, including but not limited to square, rectangle, hexagonal, diamond, oblong, or any polygon or the like, depending on the arrangement of the sidewalls 18.

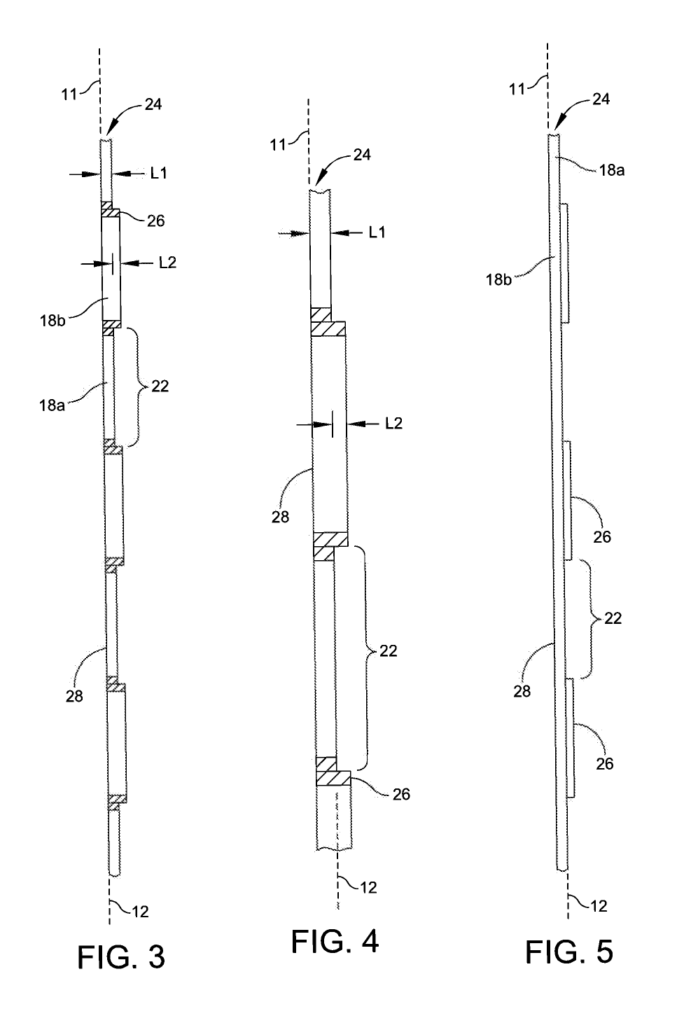

Referring now to FIGS. 3-6, food freshness device 10 also includes a plurality of legs 26 constructed and arranged to create flow channels 22 between substrate 30 (FIG. 6) and base 24. In the present embodiment, the legs 26 are formed by extending the length of a select number of sidewalls 18. As illustrated, length L1, of the sidewalls 18a is determined by the distance between the first plane 11 and the second plane 12. The length of the sidewalls 18a thus corresponds to the distance between the first plane 11 and second plane 12. However, a number of the sidewalls 18b include legs 26 extending beyond the second plane 12. The length (L2) of the legs 26 therefore corresponds to the distance between the second plane 12 and the substrate 30. The length (L2) of the legs 26, is sized to elevate the food item 29 from the substrate and to allow space for liquid to flow away from the food item through channels 22. As will be appreciated, the depth of each channel 22 is defined by the length of the legs 26 that define the channel 22. The distance between the food item resting on the surface 28 and the substrate 30 is determined by the length of the tallest legs 26, L2. As also illustrated, the sidewalls 18 and the legs 26 may be made from a singular piece of material, such that the sidewalls 18 and the legs 26 are a unitary construction, or they may be two or more separate components that are joined together, as would be known to one of skill in the art.

As best shown in FIGS. 5 and 6, the legs 26 extend beyond the second plane, and form flow channels 22. The base 24 is positioned such that at least some of the legs 26 contact the substrate 30 when the food item 29 is placed on the support surface 28. Because sidewalls 18a are elevated a distance from the substrate, flow channels 22 are created under and along the base 24, by legs 26. The base is preferably sufficiently rigid so that it does not collapse when heavier items such as such as calzones, nachos, or chicken wings are placed on the food freshness device 10, thereby maintaining the integrity of the flow channels 22, to allow for the flow of liquid and steam as described above. The base may also be sufficiently flexible to allow for insertion into any container, including containers with smaller, or irregularly sized openings. The material may be chosen in light of the food item the base is intended to support. A more rigid material may be used for heavier items, such multi topping pizza, and a less rigid material may be used for lighter food items such as baked goods. As is understood by one of skill in the art, a variety of lengths for legs 26 may be utilized, depending on the type of food item, its weight, and the anticipated amount of liquid and/or steam that will be released.

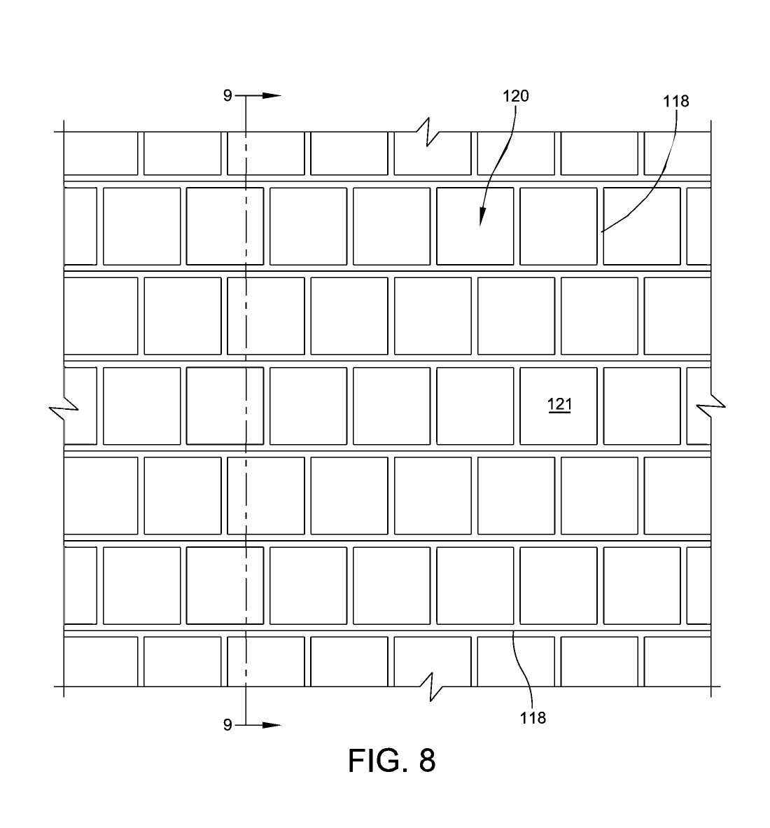

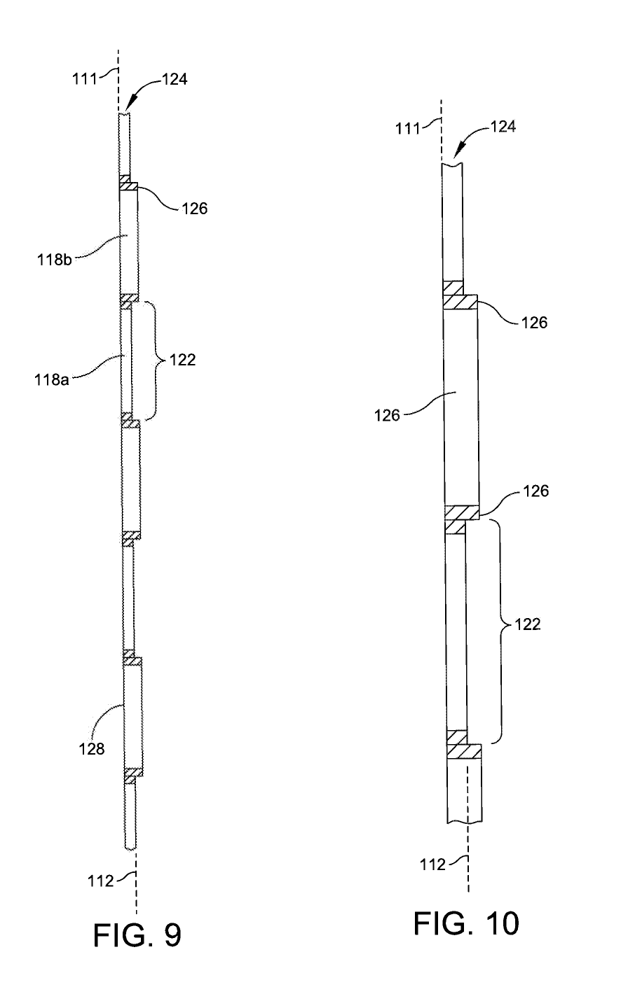

Referring now to FIGS. 7-10, a second exemplary embodiment is illustrated where the drainage cells 20 can be arranged in a variety of patterns. In this exemplary embodiment, the same or similar elements of the embodiment of FIGS. 1-6 are labeled with the same reference numbers preceded by the numeral “1.” This embodiment has the same elements as the previous embodiment, except the drainage cells 120 are arranged in an offset, staggered arrangement. In this manner, a pattern of cells having horizontal rows of drainage cells 120 that are offset from adjacent rows of drainage cells 120, so that the drainage cells 120 are not aligned in vertical rows. As with the previous embodiment, the drainage cells 120 can be square, rectangle, hexagonal, diamond, oblong, polygon or the like, depending on the arrangement of the sidewalls 118, and arranged in any offset configuration, as may be desired. Such an arrangement may be desirable depending upon the intended use of the base 124, for example the shape of the container may determine if an offset arrangement of cells 120 is desired, whether the cells be offset vertically or horizontally.

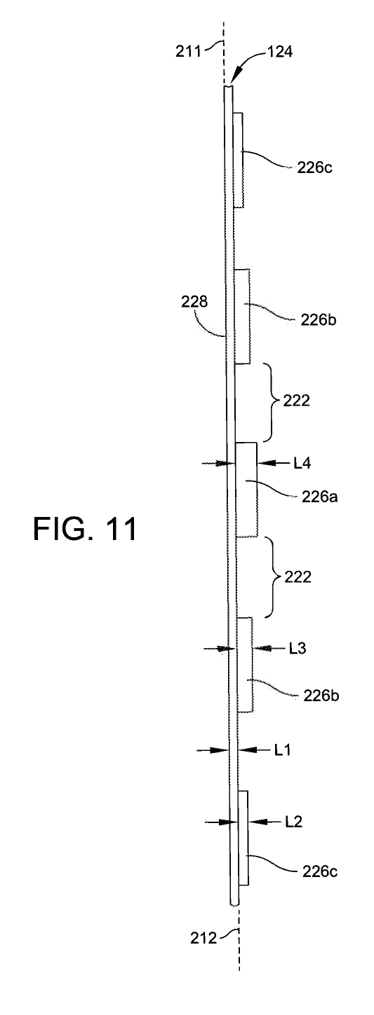

Referring now to another exemplary embodiment, as best shown by FIG. 11, the legs 226 may have different lengths within a single base 224. In this embodiment, the same or similar elements of the embodiment of FIG. 1 are labeled with the same reference numbers preceded with the numeral “2.” As shown in FIG. 11, legs 226a, 226b and 226c all have varying lengths. As illustrated in the present embodiment, the longest legs 226a, having a length L4, are positioned toward the center of the food item, while the shortest legs 226c, having a length L2 are positioned at the periphery of the food item. Legs 226b, having an intermediate length L3, are positioned in a region between legs 226a and 226c. This arrangement is advantageous for food items with a large surface area, such as pizza, in which directing steam and grease away from the center of the food item may be desirable for preserving freshness. Likewise, and by way of example only, it may be advantageous to direct the flow of liquid and steam in other directions, such as toward the center of the food item, in order to preserve freshness. For example, foods with a hole in the middle, such as donuts or bundt cake, may benefit from legs 226 of length L4 at the periphery of the food item and legs 226 of length L2 in the middle of the food item, thereby directing liquid and steam to flow toward the center of the food item.

By varying the length of the legs 226, the flow of the liquid into the area beneath the food item can be selectively directed. For instance, as shown in FIG. 11, the liquid can be directed away from the center of the base 224. The legs 226 can be arranged in any array of legs with similar lengths, selectively positioned in order to achieve the desired flow of liquid into the flow channels 222. For example, the flow could be directed from the center of the food item to the outer edges, from the front to the back, or from the outer edges to the center. In this embodiment, depending on the weight of the food item, some legs 226 may not contact the substrate 30 unless the food item is heavy enough to press the legs 226 down to contact the substrate 30.

During use, the food freshness device 10 is placed on a substrate and a hot food item 29 is removed from the oven, or taken off the stove, and placed on the support surface 28. The base 24 elevates the food item 29 above the substrate by the legs 26. The flow channels 22 allow the liquid and steam to flow away from the food item 29 and through the flow channels 22 under base 24. The flow channels 22 operate to reduce pooling in the drainage cells 20 that can result from liquid filling the cells. The channels allow liquid to flow along the length of the base 24 so as not to pool in any one area under the food item.

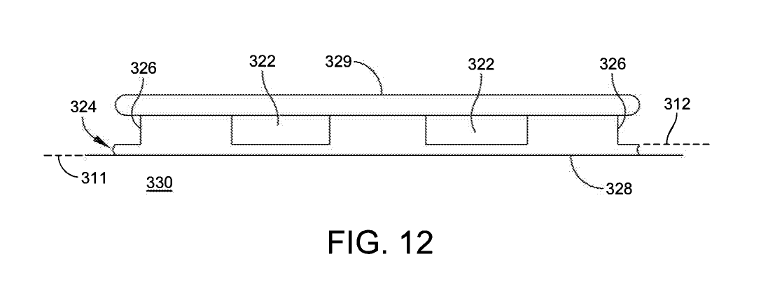

Returning now to FIG. 12, alternatively, as would be understood by one of skill in the art, the device can inverted for use, such that the surface 328 is arranged to contact a substrate 330, such as a container or a shelf. In this embodiment, the same or similar elements of the embodiment of FIG. 6 are labeled with the same reference numbers preceded with the numeral “3.” In this configuration, the second plane 312 is positioned above the first plane 311, and the legs 326 extend upward to support the food items. In this embodiment the flow channels 322 are arranged above the drainage cells 320 such that when a cell 320 fills with liquid, the liquid has room to overflow into the next cell, preventing the liquid from touching the bottom of the food item 329. The legs 326 can be arranged in a variety of lengths as to lift the food item off of the substrate by varying lengths. As described herein, by varying the length of the legs, the flow of the liquid can be directed away from the food item as desired. For instance, if legs 326 of the longest length are arranged toward the center of the food item 329, the liquid can be directed away from the center of the food item, and toward the periphery of the food item 329. Alternatively, the legs 326 can be arranged such that the longest legs 326 are in the front of the food item, and the lowest legs 326 are in the back, thereby directing the flow of liquid and steam toward the back of the box, display, or container. As is understood by one of skill in the art, the legs 326 can be arranged in any array in order to direct the flow if liquid and steam as desired.

In all of the foregoing embodiments, substrate 30 may include any type of container or display, as would be known to one of skill in the art, such as for example, pizza boxes, take-out containers, bakery shelves, bakery racks, or the like. The substrate 30 may be absorbent or non-absorbent depending on the desired packaging and use.

In addition, the food freshness device 10 of any of the foregoing embodiments may be made from a variety of materials including those that are compostable and/or recyclable, such as the material disclosed in U.S. Application No. 20170144813 A1, crystalline polylactic acid, polybutylene succinate, and compostable polyethylene terephthalate. The present embodiments may be made of crystalline polylactic acid, which is both microwavable, compostable, and biodegradable. Other materials that are microwavable and/or recyclable, biodegradable or compostable may also be utilized, as would be known to those of skill in the art. While materials that are microwavable, compostable, and/or biodegradable are desirable, any variety of material can be utilized provided that it can be formed into the desired shape, and will preferably support the weight of food items up to about 2-4 pounds.

After the food freshness device 10 of any of the foregoing embodiments is manufactured, it can be cut into the desired size for the container or display. The freshness device 10 can be made of any of variety of materials, as described above, and can be made in a variety of colors. It may also be colorless or colored to match packaging or to match a display case or shelving, so that it is not noticed in a store display.

It will be understood by those skilled in the art that various changes in the form and details may be made herein without departing from the spirit and scope of the invention as defined by the appended claims. For example, the materials disclosed herein may be readily changed, as may the dimensions and geometric configurations of the components described herein, i.e. the cells may be a variety of shapes and sizes, the length of the legs may vary, the base may be made of a variety of materials, the cells may be configured in a variety of patterns, and the channels may flow in a variety of directions. Also elements that are shown in combination may be shown in different combinations or may be eliminated. Thus, the details of these components as set forth in the above-described examples, should not limit the scope of the claims.

Further, the purpose of the Abstract is to enable the U. S. Patent and Trademark Office, and the public generally, and especially the scientists, engineers and practitioners in the art who are not familiar with patent or legal terms or phraseology, to determine quickly from a cursory inspection the nature and essence of the technical disclosure of the application. The Abstract is neither intended to define the claims of the application nor is intended to be limiting on the claims in any way.

What is claimed is:

1. A food freshness device for inhibiting reabsorption of liquid into a prepared food item that is supported on a substrate, comprising:
a base having:
(a) a support surface constructed and arranged to support the food item, the support surface disposed in a first plane arranged substantially parallel to the substrate and spaced from the substrate;
(b) a plurality of sidewalls extending from the support surface a distance to a second plane, the second plane being substantially parallel to the first plane, the plurality of sidewalls bounding openings to define drainage cells within the base, the drainage cells being constructed and arranged to direct liquid flow from the food item toward the substrate;
two or more legs extending from a select number of the plurality of sidewalls, from the second plane toward the substrate, the two or more legs defining at least one flow channel constructed and arranged to direct liquid flow along the substrate; and
wherein during use, the food item is placed on the support surface, elevated above the substrate, and wherein liquid released from the food item flows through the drainage cells, into the channels to reduce pooling of liquid of the liquid within the drainage cells.

2. The food freshness device of claim 1, wherein the base is constructed from compostable material.

3. The food freshness device of claim 1, wherein the base is constructed from microwavable material.

4. The food freshness device of claim 1, wherein the drainage cells are disposed and arranged into horizontal rows and vertical columns within the base.

5. The food freshness device of claim 1, wherein the drainage cells are constructed and arranged in horizontal rows, and each horizontal row of drainage cells is offset from the cell beneath it such that the cells are staggered within the base.

6. The food freshness device of claim 1, wherein the two or more legs are constructed and arranged to be substantially the same length.

7. The food freshness device of claim 1, wherein the two or more legs are constructed and arranged to be different length legs.

8. The food freshness device of claim 7, wherein the different length legs are grouped within the base such that legs of similar lengths are grouped together to provide channels of varying height.

9. The food freshness device of claim 8, wherein legs of greater length are positioned toward the center of the base and legs of lesser length are positioned toward the perimeter of the base.

10. The food freshness device of claim 1 in combination with a prepared food item.

11. The food freshness device of claim 1 in combination with the substrate.

12. The food freshness device of claim 1, wherein the support surface is substantially parallel to the substrate.

13. A food freshness device for retaining freshness of a prepared food item that is supported on a substrate, comprising:
a base having:
(a) a support surface;
(b) a plurality of sidewalls extending from the support surface toward the substrate, the plurality of sidewalls bounding openings to define drainage cells within the base, the drainage cells being constructed and arranged to direct liquid flow from the food item toward the substrate;
two or more legs extending from at least some of the plurality of sidewalls, the two or more legs defining at least one flow channel constructed and arranged to direct liquid flow; and
wherein during use, the food item is elevated relative to the substrate, and wherein liquid released from the food item flows through the drainage cells, into the channels to reduce pooling of liquid of the liquid within the drainage cells and inhibit reabsorption of the liquid into the food item.

14. The food freshness device of claim 13, wherein the support surface is constructed and arranged to support the food item.

15. The food freshness device of claim 13, wherein the support surface is supported on the substrate and the food item is supported on the two or more legs.

16. The food freshness device of claim 13, wherein the device is constructed from compostable material.

17. The food freshness device of claim 1, wherein the drainage cells are disposed and arranged into horizontal rows and vertical columns within the base.

18. The food freshness device of claim 1, wherein the drainage cells are constructed and arranged in horizontal rows, and each horizontal row of drainage cells is offset from the cell beneath it such that the cells are staggered within the base.

19. The food freshness device of claim 1, wherein the two or more legs are constructed and arranged to be different length legs.

20. The food freshness device of claim 7, wherein the different length legs are grouped within the base such that legs of similar lengths are grouped together to provide channels of varying height.

21. The food freshness device of claim 8, wherein legs of greater length are positioned toward the center of the base and legs of lesser length are positioned toward the perimeter of the base.
